(19) United States
(12) Patent Application Publication
(10) Pub. No.: US 2018/0147431 A1
(43) Pub. Date: May 31, 2018

(54) SAFETY SYSTEM FOR FIRE SUPPRESSANT DISTRIBUTION DEVICES

(71) Applicant: Kidde Graviner Limited, Berkshire (GB)

(72) Inventors: Adam CHATTAWAY, Windsor (GB); Harlan HAGGE, Knightdale, NC (US); Terry SIMPSON, Wake Forest, NC (US)

(21) Appl. No.: 15/827,298

(22) Filed: Nov. 30, 2017

(30) Foreign Application Priority Data
Nov. 30, 2016 (GB) 1620343.2

(51) Int. Cl. A62C 35/02; A62C 5/00; A62C 35/13

(52) U.S. Cl. CPC A62C 35/023; A62C 35/13; A62C 5/006

(57) ABSTRACT

A fire suppressant discharge device is disclosed for connection to a mounting frame 30 and/or to fire suppressant distribution pipework 26. The device comprises an electrical firing circuit 20 configured to cause fire suppressant to be discharged from a discharge valve if triggered, and at least one arming switch 24 in the firing circuit 20 that is movable between an open position and a closed position. The arming switch 24 is arranged on the device and configured so as to be automatically moved to the closed position by connection of the device to a mounting frame 30 and/or to fire suppressant distribution pipework 24 so as to arm the firing circuit 20.

### FOREIGN PRIORITY

This application claims priority to Great Britain Application No. 1620343.2 filed Nov. 30, 2016, the entire contents of which is incorporated herein by reference.

### FIELD OF THE INVENTION

The present invention relates generally to fire suppressant discharge devices and particularly to a safety mechanism for preventing the inadvertent discharge of such a device.

### BACKGROUND

It is well known to store fire suppressant in a cylinder. The cylinder has a discharge valve that is configured to be opened when it is desired to discharge the suppressant. For example, the valve may comprise a rupturable diaphragm and an explosive charge. When it is desired to dispense the fire suppressant, the explosive charge is triggered, which ruptures the diaphragm and allows the fire suppressant to escape the cylinder through the valve. Hybrid fire suppression systems are also known, which comprise a solid propellant gas generator and a cylinder of inert gas for use in suppressing fires. When it is desired to discharge the inert gas, an ignitor in the gas generator is triggered, which ignites the solid propellant material, thereby generating inert gases. These gases pass into the cylinder, causing the internal pressure therein to rise until the inert gas breaks through a burst disc in a discharge valve. U.S. Pat. No. 6,257,341 is an example of such a hybrid system.

During storage and movement of the above systems it is highly undesirable and potentially hazardous to allow the fire suppressant to inadvertently discharge. For example, if the discharge valve is accidentally opened then the escaping gas may cause the cylinder to violently recoil. In order to reduce the hazard of such inadvertent discharge, it is known to secure an anti-recoil cap over the discharge valve of the gas cylinder. An anti-recoil cap has pairs of apertures arranged therein, wherein each pair comprises a first aperture that allows gas to exit the cap along a first direction and a second aperture that allows the gas to exit the cap in a second, opposite direction. Accordingly, if the discharge valve inadvertently opens then gas is discharged from the cap in opposing directions, such that there is substantially no net force on the cap due to the discharge. This substantially eliminates recoil of the cylinder during gas discharge.

However, such anti-recoil caps must be removed before the discharge valve can be connected to other equipment for receiving the fire suppressant. For example, the anti-recoil cap must be removed from the gas cylinder before the cylinder can be mounted in the mounting bracket and/or connected to gas distribution pipework. Removal of the anti-recoil cap therefore poses a potential safety hazard during this period, since the valve may be inadvertently actuated.

### SUMMARY

A first set of embodiments of the invention provide a fire suppressant discharge device for connection to a mounting frame and/or to fire suppressant distribution pipework, comprising: a discharge valve; an electrical firing circuit configured to cause fire suppressant to be discharged from the discharge valve if triggered; and at least one arming switch in the firing circuit that is movable between an open position in which it prevents the firing circuit being triggered and a closed position in which the firing circuit is capable of being triggered; wherein the arming switch is arranged on the device and configured so as to be automatically moved to said closed position by connection of the device to a mounting frame and/or to fire suppressant distribution pipework.

The arming switch may also be arranged on the device and configured so as to be automatically moved to said open position by disconnection of the device from the mounting frame and/or from the fire suppressant distribution pipework.

The switch may be arranged on an exterior surface of the device.

The switch may be arranged on a portion of the device for contacting the mounting frame or distribution pipework when connected thereto.

The switch may be arranged proximate, on or adjacent to the discharge valve.

The arming switch may be biased to the open position.

The arming switch may comprise a mechanical switch; such as a micro-switch, a rocker switch, a button switch that closes the firing circuit when depressed, or a sliding switch that closes the firing circuit when slid; or the switch may be configured to be moved from the open position to the closed position when proximate a magnet.

The device may comprise a storage vessel having said discharge valve thereon and containing fire suppressant, optionally pressurised fire suppressant.

The fire suppressant may comprise one or more of the following fire suppressants: (i) gas; (ii) vapour; (iii) liquid; (iv) powder; and (v) foam. For example, the fire suppressant may be inert gas.

The discharge valve may be closed by a rupturable member, and the firing circuit may be connected to an explosive charge and configured to detonate the explosive charge when triggered so as to rupture the rupturable member and allow the fire suppressant to be discharged through the valve.

The rupturable member may be ruptured by the increase in pressure differential across the member due to the detonation, or due to damage to the rupturable member from the detonation.

Alternatively, the discharge valve may comprises an actuator and a closure member, and the firing circuit may be configured to control the actuator, when triggered, so as to move the closure member to an open position that allows the fire suppressant to be discharged through the valve. The actuator may comprise a solenoid in the firing circuit.

Alternatively, the discharge valve may comprise an actuator, a closure member and a piercing member, wherein the firing circuit may be configured to control the actuator, when triggered, so as to move the piercing member such that it pierces the closure member so as to allow the fire suppressant to be discharged through the valve. The actuator may comprise a solenoid in the firing circuit.

The device may include a gas generator comprising an activator configured to cause the generator to generate gas when activated, wherein the firing circuit is connected to the activator and is configured to activate the activator when the firing circuit is triggered.

The gas generator may comprise solid propellant and the activator may be configured to ignite the propellant when activated so as to initiate combustion of the propellant and generate gas.

The device may comprise a gas storage vessel, wherein the gas storage vessel is arranged such that gas generated by the gas generator passes into the vessel, and wherein the vessel comprises said discharge valve.

The discharge valve may be configured such that gas is automatically discharged from the storage vessel through the discharge valve when the pressure differential across the valve rises above a threshold pressure. For example, the discharge valve may be a burst disc.

The storage vessel may contains fire suppressant prior to activation of the gas generator.

The fire suppressant may comprise one or more of the following fire suppressants: (i) gas; (ii) vapour; (iii) liquid; (iv) powder; and (v) foam.

Said at least one arming switch may comprise a first arming switch and a second arming switch, and the first and second arming switches may be configured such that if either switch is in its open position then the firing circuit is prevented from being triggered and such that both switches must be in their closed positions for the firing circuit to be capable of being triggered.

Each of the first and second arming switches may have any of the features described herein.

The first arming switch may be arranged and configured so as to be automatically closed upon connection of the fire suppressant discharge device to the mounting frame, and the second arming switch may be arranged and configured so as to be automatically closed upon connection of the fire suppressant discharge device to the fire suppressant distribution pipework.

Embodiments of the invention provides a fire suppressant discharge assembly comprising the fire suppressant discharge device described herein and said mounting frame and/or fire suppressant distribution pipework;

(i) wherein the fire suppressant discharge device and the mounting frame are configured such that the fire suppressant discharge device is connectable to the mounting frame so as to be held in position thereby; and/or

(i) wherein the fire suppressant discharge device and the fire suppressant distribution pipework are configured such that the fire suppressant discharge device is connectable to the fire suppressant distribution pipework such that the discharge valve is able to deliver the fire suppressant into the pipework.

The at least one arming switch may be configured to be moved from the open position to the closed position when proximate a magnet, and wherein the mounting frame and/or fire suppressant distribution pipework comprises said magnet.

A magnet may be arranged on the mounting frame adjacent or proximate to a location at which the at least one switch is located when the suppressant discharge device is mounted in the mounting frame; and/or a magnet may be arranged on the fire suppressant distribution pipework adjacent or proximate to a location at which the at least one switch is located when the suppressant discharge device is connected to the fire suppressant distribution pipework.

Said switch may be arranged proximate, on or adjacent to the discharge valve; and the magnet may be arranged on the mounting frame and/or on the fire suppressant distribution pipework to be proximate or adjacent to the discharge valve when the fire suppressant discharge device is connected to the mounting frame and/or fire suppressant distribution pipework.

Embodiments of the invention also provide a method of installing a fire suppressant discharge device, comprising: providing a fire suppressant discharge assembly as described herein; and connecting the fire suppressant discharge device to the mounting frame and/or fire suppressant distribution pipework.

It is also contemplated that the firing circuit of the device described herein need not have an arming switch that is movable between two positions, but may instead have open electrical contacts that are completed by mounting the device to the mounting frame and/or fire suppressant distribution pipework.

Accordingly, a second set of embodiments of the invention provide a fire suppressant discharge device for connection to a mounting frame and/or to fire suppressant distribution pipework, comprising: a discharge valve; and an electrical firing circuit for causing fire suppressant to be discharged from the discharge valve if triggered, said circuit being electrically broken by at least one pair of spaced apart electrical contacts so as to prevent the firing circuit being triggered, wherein the electrical contacts are arranged on the device and configured so that when the device is connected to a mounting frame and/or to fire suppressant distribution pipework, the electrical contacts contact the mounting frame and/or fire suppressant distribution pipework so as to electrically complete the firing circuit so that it is capable of being triggered.

Disconnection of the device from the mounting frame and/or fire suppressant distribution pipework electrically breaks the firing circuit so as to prevent it being triggered.

The device may have any of the features described in relation to the first set of embodiments, except wherein the arming switch on the device is replaced by the open electrical contacts on the device.

For example, the electrical contacts may be spaced apart and arranged on an exterior surface of the device.

The electrical contacts may be arranged on a portion of the device for contacting the mounting frame or distribution pipework when connected thereto.

The electrical contacts may be arranged proximate, on or adjacent to the discharge valve.

The device may have any of the features of the storage vessel described herein.

The discharge valve may have any of the features of the discharge valve described herein.

Said at least one pair of electrical contacts may comprise a first pair of contacts and a second pair of contacts, and the first and second pairs of contacts may be configured such that if either pair of contacts remains open then the firing circuit is prevented from being triggered and such that both pairs of contacts must be electrically closed for the firing circuit to be capable of being triggered. Each of the first and second pair of contacts may have any of the features described herein.

The first pair of contacts may be arranged and configured so as to be electrically closed by the mounting frame when the fire suppressant discharge device is connected to the mounting frame, and the second pair of contacts may be arranged and configured so as to be electrically closed by the fire suppressant distribution pipework when the fire suppressant discharge device is connected to the mounting frame.

It is contemplated that the firing circuit may comprise an arming switch according to the first set of embodiments and a pair of electric contacts according to the second pair of embodiments.

The second set of embodiments also provides a fire suppressant discharge assembly comprising the fire suppressant discharge device according to the second set of embodiments and said mounting frame and/or fire suppressant distribution pipework; (i) wherein the fire suppressant discharge device and the mounting frame are configured such that the fire suppressant discharge device is connectable to the mounting frame so as to be held in position thereby; and/or (i) wherein the fire suppressant discharge device and the fire suppressant distribution pipework are configured such that the fire suppressant discharge device is connectable to the fire suppressant distribution pipework such that the discharge valve is able to deliver the fire suppressant into the pipework.

The portion(s) of the mounting frame and/or distribution pipework that are contacted by said at least one pair of electrical contacts are electrically conductive so as to close the firing circuit.

Embodiments of the invention also provide a method of installing a fire suppressant discharge device, comprising: providing a fire suppressant discharge assembly as described in relation to the second set of embodiments; and connecting the fire suppressant discharge device to the mounting frame and/or fire suppressant distribution pipework.

The mounting bracket described herein may be a frame, a mounting lug, a hook or any other structure on or in which the device may be mounted.

### BRIEF DESCRIPTION OF THE DRAWINGS

Various embodiments will now be described, by way of example only, and with reference to the accompanying drawings in which:

FIG. 1 shows a conventional anti-recoil cap for a gas cylinder;

FIGS. 2A-2B show schematics of a first embodiment of the invention in which a firing circuit is armed by connection of pipework to the gas cylinder; and

FIGS. 3A-3B show schematics of a second embodiment of the invention in which a firing circuit is armed by mounting the gas cylinder in a mounting bracket.

### DETAILED DESCRIPTION

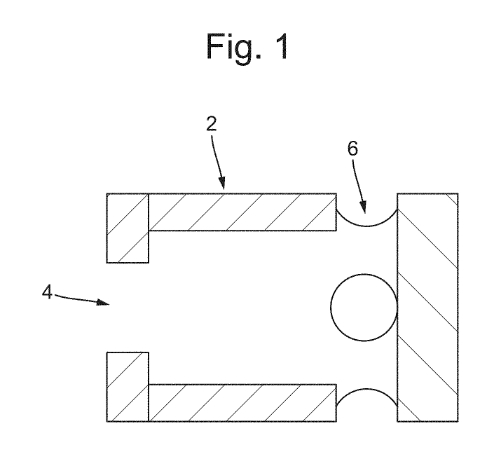

FIG. 1 shows a schematic of a known anti-recoil safety cap. The cap comprises a housing 2 having an entrance port 4 for securing to a gas cylinder over the discharge port of the gas cylinder. The cap also has anti-recoil apertures 6 extending through the housing 2 for allowing fluid communication between the entrance port 4 and the exterior of the safety cap. The anti-recoil apertures 6 are arranged in pairs, with a first anti-recoil aperture in each pair located so that gas may exit the housing 2 in a first direction and a second anti-recoil aperture located so that gas may simultaneously exit the housing 2 in a second direction opposite to the first direction. The axes through the anti-recoil apertures 6 in each pair are desirably coaxial. Any number of pairs of anti-recoil apertures 6 may be provided, although the sectional view of FIG. 1 shows a first pair and one of the apertures of a second pair.

The safety cap is connected to the gas cylinder prior to storage, transportation and handling, i.e. for the period before it is desired that gas is discharged from the gas cylinder. If the discharge valve of the gas cylinder is inadvertently triggered to open, then the pressurised gas (or other fire suppressant) will exit the cylinder through the discharge valve and pass into the entrance port 4 of the safety cap. The gas will then pass out of the anti-recoil apertures 6. As the anti-recoil apertures 6 are arranged in pairs as described above, the gas will exit the cap in opposite directions with substantially the same magnitude in each direction. As such, although the cap does not prevent the gas from being discharged inadvertently, it does prevent such a gas discharge from causing the cap (and hence the cylinder) from violently recoiling.

Although gas may inadvertently discharge as described above, it is desired that the gas will not be discharged until the desired moment, e.g. after the cylinder has been mounted in a mounting bracket and/or until the discharge valve has been arranged in fluid communication with distribution pipework. This requires the anti-recoil cap to be removed from the cylinder, thus posing a safety hazard until the cylinder has been mounted and/or connected.

Embodiments of the present invention reduce the safety hazard posed by gas cylinders (or other fire suppressant discharge devices), whether an anti-recoil cap is required to be removed or not.

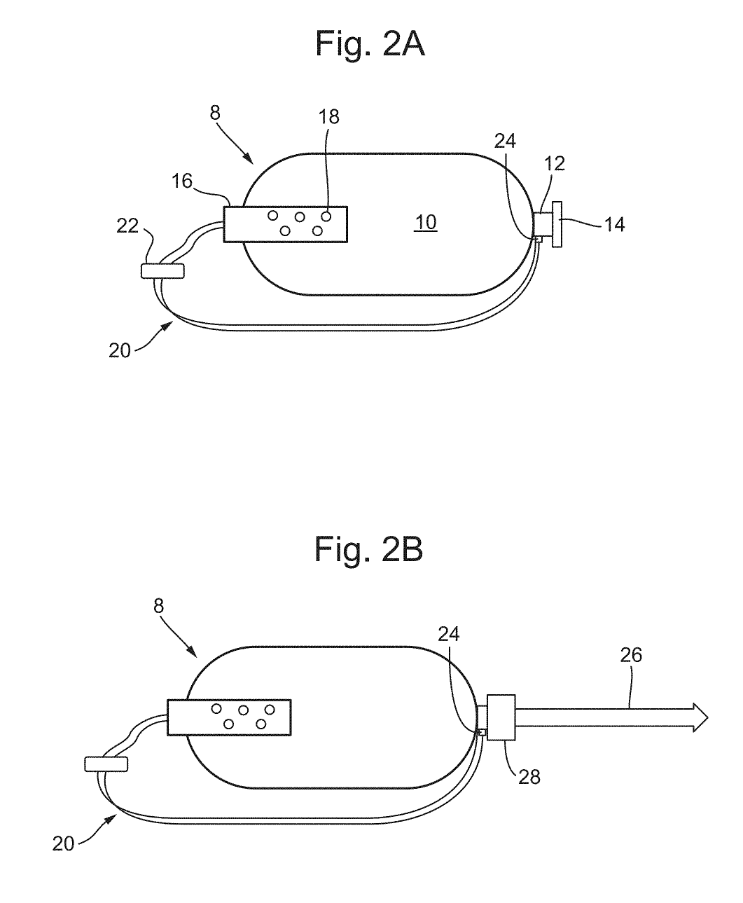

FIG. 2A shows a schematic of a fire suppressant discharge device according to an embodiment of the present invention. The device comprises a gas cylinder 8 that houses inert gas 10, such as nitrogen, for use in suppressing a fire. The cylinder 8 comprises a discharge valve 12 including a burst disc therein, and an anti-recoil cap 14 such as that described in relation to FIG. 1 and that is removably connected to the cylinder 8 over the discharge valve 12. The cylinder 8 also houses a solid propellant gas generator 16 for use in generating an inert gas. The gas generator 16 comprises pellets of solid propellant material (e.g. sodium azide), an activator for igniting the propellant, and gas exhaust vents or nozzles 18. The device further comprises an electrical firing circuit 20 for activating the activator of the gas generator 16 when the firing circuit 20 is triggered. Signals for triggering the firing circuit 20 may be received through an interface module 22. For example, the interface module 22 may be connected to a fire and/or smoke detector for triggering the firing circuit 20. The firing circuit 20 comprises an arming switch 24, such as a micro-switch, located on the collar of the cylinder 8 under the anti-recoil cap 14. The arming switch 24 is biased to an open position so as to break the firing circuit 20 such that it is impossible for the firing circuit 20 to activate the activator of the gas generator 16.

FIG. 2B shows a schematic of the embodiment of FIG. 2A after removal of the anti-recoil cap 14 and connection of the discharge valve to fire suppressant distribution pipework 26. The arming switch 24 is arranged on an external surface of the cylinder 8 and configured to cooperate with the fire suppressant distribution pipework 26 such that the step of connecting the fire suppressant distribution pipework 26 to the cylinder 8 automatically closes the arming switch 24 so as to complete the firing circuit 20. For example, a collar 28 on the fire suppressant distribution pipework 26 may slide over the arming switch 24, so as to depress the switch 24 and close the firing circuit 20. The firing circuit 20 is then primed and capable of triggering the activator of the gas generator 16 if a triggering signal is received at the interface module 22.

It will therefore be appreciated that it is not possible for the firing circuit 20 to trigger the activator of the gas generator 16 until the discharge valve 12 of the cylinder 8 is safely connected to the fire suppressant distribution pipework 26, since the arming switch 24 is only moved to the closed position during the connection. This prevents the firing circuit 20 from triggering gas to be released from the cylinder 8 prior connection of the cylinder 8 to the pipework 26, thus improving the safety of the apparatus. Similarly, if the discharge valve 12 of the cylinder 8 is disconnected from the fire suppressant distribution pipework 26, the arming switch 24 may automatically move to the open position, again preventing the firing circuit 20 from triggering gas to be released from the cylinder 8.

When the fire suppression system detects a potential fire, e.g. via the heat and/or smoke detector, a triggering signal is generated and sent to the interface module 22. Once the cylinder 8 has been connected to the distribution pipework 26, the arming switch 24 is closed and so the triggering signal causes the firing circuit 20 to activate the activator in the gas generator 16. This ignites the solid propellant material and initiates the combustion thereof, thereby generating inert combustion gas. The inert combustion gases exit the gas generator 16 through the exhaust vents or nozzles 18 in an exhaust and pass into the main body of the cylinder 8. The vents or nozzles 18 may be arranged so as to negate any net force on the exhaust caused by the flow of the gas. For example, the vents or nozzles 18 may be arranged in pairs on the exhaust, with one vent or nozzle of the pair on one side of the exhaust and another vent or nozzle of the pair on the opposing side of the exhaust. The vents or nozzles 18 may also be arranged so as to promote mixing of the gases exhausted from the gas generator 16 with the other gas initially stored in the main body of the cylinder 8. This serves to cool the hot gas exhausted from the gas generator 16. It will be appreciated that ratio of the quantity of gas generated by the gas generator 16 to the quantity of gas initially stored in the main body of the cylinder 8 may be selected during design of the system such that the mixed gas has the desired temperature when discharged.

The gas passing from the gas generator 16 into the main body of the cylinder 8 causes the gas pressure inside of the main body of the cylinder 8 to rise. The burst disc in the discharge valve 12 is configured to seal the gas inside the main body of the cylinder 8 until that gas reaches a predetermined pressure. Once the gas inside the main body of the cylinder 8 has risen above this predetermined pressure, the gas overcomes the burst disc and passes through the distribution pipework 26 to the area to be protected from fire. The inert gas may then dilute the oxygen concentration in the area to be protected such that a fire in that area is suppressed or prevented from being established.

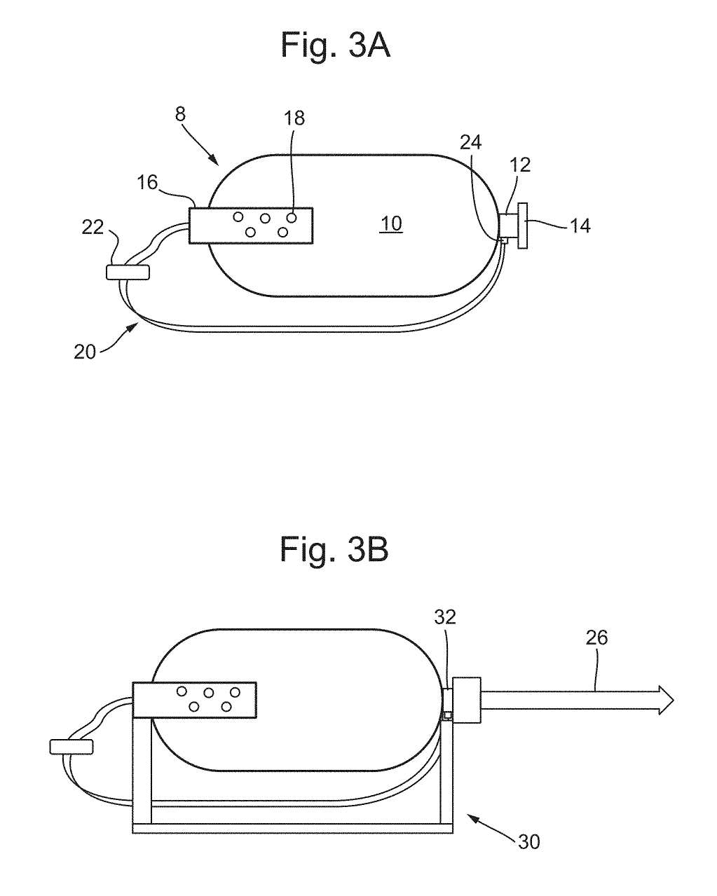

FIGS. 3A-3B show schematics of another embodiment that is substantially the same as that of FIGS. 2A-2B except that the arming switch 24 is arranged and configured to cooperate with a mounting bracket 30 such that the step of connecting the cylinder 8 to the mounting bracket 30 automatically closes the arming switch 24 so as to complete the firing circuit 20. For example, the arming switch 24 may be located on an external surface of the cylinder collar 32 and the mounting bracket 30 may be configured so as to receive the collar 32 of the cylinder 8 in a manner that depresses the arming switch 24 and therefore closes the firing circuit 20. The firing circuit 20 is then primed and capable of triggering the activator on the gas generator 16 if a triggering signal is received at the interface module 22. Distribution pipework 26 may also be connected to the cylinder 8 before or after it has been mounted in the bracket 30.

It will therefore be appreciated that it is not possible for the firing circuit 20 to trigger the activator of the gas generator 16 until the cylinder 8 is safely mounted and connected in the mounting bracket 30, since the arming switch 24 is only moved to the closed position during this connection. This prevents the firing circuit 20 from triggering gas to be released from the cylinder 8 prior connection of the cylinder 8 to the mounting bracket 30, thus improving the safety of the apparatus. Similarly, if the cylinder 8 is demounted from the mounting bracket 30, the arming switch 24 may automatically move to the open position, again preventing the firing circuit 20 from triggering gas to be released from the cylinder 8.

Various embodiments have been described which provide a device in which the firing circuit is prevented from being triggered prior to mounting of the device in a mounting frame and/or prior to connection to the fire suppressant distribution pipework. As such, embodiments of the device present a lower safety hazard that conventional devices.

Although the present invention has been described with reference to embodiments, it will be understood by those skilled in the art that various changes in form and detail may be made without departing from the scope of the invention as set forth in the accompanying claims.

For example, although embodiments have been described in which the arming switch closes the firing circuit when the cylinder is either connected to distribution pipework or to a mounting bracket, it is contemplated that a first arming switch may be provided that automatically closes when the cylinder is connected to the mounting bracket and a second arming switch may be provided that automatically closes when the cylinder is connected to the pipework. The first and second arming switches may then ensure that the triggering circuit is closed and primed only when the cylinder is mounted in the bracket and connected to the pipework.

Although the arming switch has been described as being a micro-switch, it may be any mechanical switch capable of fulfilling the function described above. For example, the arming switch may be a rocker switch, a button switch that closes the firing circuit when depressed, or a sliding switch that closes the firing circuit when slid. Alternatively, the switch may be configured to be moved from the open position to the closed position when proximate a magnet. Accordingly, a magnet may be arranged on the mounting bracket and/or pipework so as to activate the switch.

Although a hybrid discharge system having both a gas cylinder and a gas generator has been described, it is contemplated that a gas generator may be used without the cylinder or a cylinder of fire suppressant may be used without the gas generator. It is also contemplated that a gas generator of a type other than a solid propellant gas generator may be used.

It is contemplated that the firing circuit may initiate the discharge of the fire suppressant via means other than activating a gas generator. For example, the triggering circuit may directly trigger the opening of the discharge valve on a storage vessel containing fire suppressant. By way of example, the firing circuit may be connected to an explosive charge that ruptures a rupturable member in the valve when detonated so as to allow the fire suppressant to be discharged through the valve. Alternatively, the discharge valve may comprise an actuator and a closure member, wherein the firing circuit is configured to control the actuator, when triggered, so as to move the closure member to an open position that allows the fire suppressant to be discharged through the valve. Alternatively, the discharge valve may comprises an actuator, a closure member and a piercing member, and wherein the firing circuit is configured to control the actuator, when triggered, so as to move the piercing member such that it pierces the closure member so as to allow the fire suppressant to be discharged through the valve.

Although the firing circuit has been described as having an arming switch 24 on the device that is moved between open and closed positions during connection, the arming switch 24 may alternatively be formed by open electrical contacts on the external surface of the cylinder 8 which are electrically closed by the fire suppressant distribution pipework 26 when the cylinder 8 is connected to the pipework 26, or which are electrically closed by the mounting frame 30 when the cylinder 8 is connected to the frame 30.

1. A fire suppressant discharge device for connection to a mounting frame or to fire suppressant distribution pipework, comprising:
a discharge valve;
an electrical firing circuit configured to cause fire suppressant to be discharged from the discharge valve if triggered; and
at least one arming switch in the firing circuit that is movable between an open position in which it prevents the firing circuit being triggered and a closed position in which the firing circuit is capable of being triggered;
wherein the arming switch is arranged on the device and configured so as to be automatically moved to said closed position by connection of the device to a mounting frame and/or to fire suppressant distribution pipework.

2. The device of claim 1, wherein the switch is arranged on an exterior surface of the device.

3. The device of claim 1, wherein the switch is arranged on a portion of the device for contacting the mounting frame or distribution pipework when connected thereto.

4. The device of claim 1, wherein the switch is arranged proximate, on or adjacent to the discharge valve.

5. The device of claim 1, wherein the arming switch comprises a mechanical switch; such as a micro-switch, a rocker switch, a button switch that closes the firing circuit when depressed, or a sliding switch that closes the firing circuit when slid; or
wherein the switch is configured to be moved from the open position to the closed position when proximate a magnet.

6. The device of claim 1, comprising a storage vessel having said discharge valve thereon and containing fire suppressant, optionally pressurised fire suppressant.

7. The device of claim 1, wherein the discharge valve is closed by a rupturable member, and wherein the firing circuit is connected to an explosive charge and is configured to detonate the explosive charge when triggered so as to rupture the rupturable member and allow the fire suppressant to be discharged through the valve.

8. The device of claim 1, wherein the discharge valve comprises an actuator and a closure member, and wherein the firing circuit is configured to control the actuator, when triggered, so as to move the closure member to an open position that allows the fire suppressant to be discharged through the valve; or
wherein the discharge valve comprises an actuator, a closure member and a piercing member, and wherein the firing circuit is configured to control the actuator, when triggered, so as to move the piercing member such that it pierces the closure member so as to allow the fire suppressant to be discharged through the valve.

9. The device of claim 1, including a gas generator comprising an activator configured to cause the generator to generate gas when activated, wherein the firing circuit is connected to the activator and is configured to activate the activator when the firing circuit is triggered.

10. The device of claim 9, comprising a gas storage vessel, wherein the gas storage vessel is arranged such that gas generated by the gas generator passes into the vessel, and wherein the vessel comprises said discharge valve.

11. The device of claim 1, wherein said at least one arming switch comprises a first arming switch and a second arming switch, and wherein the first and second arming switches are configured such that if either switch is in its open position then the firing circuit is prevented from being triggered and such that both switches must be in their closed positions for the firing circuit to be capable of being triggered.

12. A fire suppressant discharge assembly comprising the fire suppressant discharge device claim 1 and said mounting frame or fire suppressant distribution pipework;
(i) wherein the fire suppressant discharge device and the mounting frame are configured such that the fire suppressant discharge device is connectable to the mounting frame so as to be held in position thereby; or
(i) wherein the fire suppressant discharge device and the fire suppressant distribution pipework are configured such that the fire suppressant discharge device is connectable to the fire suppressant distribution pipework such that the discharge valve is able to deliver the fire suppressant into the pipework.

13. The assembly of claim 12, wherein the at least one arming switch is configured to be moved from the open position to the closed position when proximate a magnet, and wherein the mounting frame and/or fire suppressant distribution pipework comprises said magnet.

14. The assembly of claim 13, wherein said switch is arranged proximate, on or adjacent to the discharge valve; and the magnet is arranged on the mounting frame and/or on the fire suppressant distribution pipework to be proximate or adjacent to the discharge valve when the fire suppressant discharge device is connected to the mounting frame and/or fire suppressant distribution pipework.

15. A fire suppressant discharge device for connection to a mounting frame and/or to fire suppressant distribution pipework, comprising:
a discharge valve; and
an electrical firing circuit for causing fire suppressant to be discharged from the discharge valve if triggered, said circuit being electrically broken by at least one pair of spaced apart electrical contacts so as to prevent the firing circuit being triggered, wherein the electrical contacts are arranged on the device and configured so that when the device is connected to a mounting frame and/or to fire suppressant distribution pipework, the electrical contacts contact the mounting frame or fire suppressant distribution pipework so as to electrically complete the firing circuit so that it is capable of being triggered.
